(19) United States
(12) Patent Application Publication
(10) Pub. No.: US 2015/0156375 A1
(43) Pub. Date: Jun. 4, 2015

(54) IMAGE PROCESSING APPARATUS, METHOD OF CONTROLLING THE SAME, AND STORAGE MEDIUM

(71) Applicant: Canon Kabushiki Kaisha, Tokyo (JP)

(72) Inventor: Hiroyasu Morita, Yokohama-shi (JP)

(21) Appl. No.: 14/520,870

(22) Filed: Oct. 22, 2014

(30) Foreign Application Priority Data
Nov. 29, 2013 (JP) 2013-248345

(51) Int. Cl. H04N 1/44; H04N 1/00

(52) U.S. Cl. CPC H04N 1/4413; H04N 1/001; H04N 2201/0039; H04N 2201/3204

(57) ABSTRACT

An image processing apparatus control a display unit to display a first screen for inputting a host name of a destination server, performs, based on the host name input via the first screen, a verification of the destination server, control the display unit to display, based on a result of the verification, a second screen for inputting authentication information for logging in to the destination server, and transmits image data using the authentication information input via the second screen.

### BACKGROUND OF THE INVENTION

1. Field of the Invention

The present invention relates to an image processing apparatus that transmits image data obtained by reading from an original to a transmission destination that a user designates, to a method of controlling the same, and to a storage medium.

2. Description of the Related Art

In recent years, multi function peripherals capable of executing a plurality of functions such as a copy function, a print function, a fax function, a network scan function, an address book for managing transmission destination information, or the like, are used widely. Normally, such multi function peripherals are equipped with an operation unit that has an operation panel having a touch screen function and hard keys, and a user is able to operate the device by calling a desired function from a function list displayed on the operation panel. With a network scan function that a multi function peripheral is provided with, image data can be transmitted using a fax transmission, an e-mail transmission, an I-Fax transmission, a file transmission, or the like. Furthermore, in the file transmission, the image data can be transmitted to a server that a user chooses using various transmission protocols such as FTP, SMB, or WebDAV. Multi function peripherals are equipped with an address setting unit according to these multiple transmission approaches, and a transmission setting unit for setting the transmission file format, or the like, and a user is able to transmit image data to a desired destination by operating these. In Japanese Patent Laid-Open No. 2005-318545, a document processing apparatus capable of transmitting document data in accordance with multiple differing transmission protocols has been proposed.

However, there is a problem with the above described conventional technique as described below. Unlike in fax transmission, e-mail transmission, and I-Fax transmission, in file transmission, authentication information for the server is necessary when transmitting the image data to a server other than in exceptional cases. If a server, which is a transmission partner, is a server that can be relied upon, it is not a problem to send authentication information such as a user name and a password at the time of transmission. However, there are cases in which, by the file transmission protocol, it is possible to transmit the authentication information to an external server, and if the partner server is a malicious server, there is the possibility that the authentication information will be extracted and misused. There is the possibility that this will cause a serious problem in terms of security.

### SUMMARY OF THE INVENTION

The present invention enables realization of an arrangement that prevents leaking, to a malicious server, information input when a data transmission destination is set

One aspect of the present invention provides an image processing apparatus, comprising: a first display control unit configured to control a display unit to display a first screen for inputting a host name of a destination server; a verification unit configured to perform, based on the host name input via the first screen, a verification of the destination server; a second display control unit configured to control the display unit to display, based on a result of the verification by the verification unit, a second screen for inputting authentication information for logging in to the destination server; and a transmission unit configured to transmit image data using the authentication information input via the second screen.

Another aspect of the present invention provides an image processing apparatus, comprising: a first acceptance unit configured to accept a host name of a destination server; a verification unit configured to perform, based on the host name that the first acceptance unit accepts, a verification of the destination server; a second acceptance unit configured to, based on a result of the verification by the verification unit, accept authentication information for logging in to the destination server; and a transmission unit configured to transmit image data using the authentication information that the second acceptance unit accepts.

Still another aspect of the present invention provides a method of controlling an image processing apparatus, comprising: controlling a display unit to display a first screen for inputting a host name of a destination server; performing, based on the host name input via the first screen, a verification of the destination server; controlling the display unit to display, based on a result of the verification, a second screen for inputting authentication information for logging in to the destination server; and transmitting image data using the authentication information input via the second screen.

Yet still another aspect of the present invention provides a method of controlling an image processing apparatus, comprising: accepting a host name of a destination server; performing, based on the host name, a verification of the destination server; based on a result of the verification, accepting authentication information for logging in to the destination server; and transmitting image data using the authentication information.

Still yet another aspect of the present invention provides a non-transitory computer-readable storage medium storing a program for causing a computer to execute a method of controlling an image processing apparatus, the program comprising: controlling a display unit to display a first screen for inputting a host name of a destination server; performing, based on the host name input via the first screen, a verification of the destination server; controlling the display unit to display, based on a result of the verification, a second screen for inputting authentication information for logging in to the destination server; and transmitting image data using the authentication information input via the second screen.

Yet still another aspect of the present invention provides a non-transitory computer-readable storage medium storing a program for causing a computer to execute a method of controlling an image processing apparatus, the program comprising: accepting a host name of a destination server; performing, based on the host name, a verification of the destination server; based on a result of the verification, accepting authentication information for logging in to the destination server; and transmitting image data using the authentication information.

Further features of the present invention will be apparent from the following description of exemplary embodiments with reference to the attached drawings.

### BRIEF DESCRIPTION OF THE DRAWINGS

FIG. 1 is a block diagram for showing an overview configuration of an image processing apparatus according to a first embodiment.

FIG. 2 is a block diagram for showing a software configuration for controlling the image processing apparatus according to the first embodiment.

FIG. 3 is a block diagram of a system to which the first embodiment is applied.

FIG. 4 is a view for showing an example of a home screen displayed on an operation unit 105 according to the first embodiment.

FIG. 5 is a view for showing an example of a scan operation screen displayed on the operation unit 105 according to the first embodiment.

FIG. 6 is a view for showing an example of a destination type selection screen displayed on the operation unit 105 according to the first embodiment.

FIG. 7 is a view for showing an example of a file destination setting screen displayed on the operation unit 105 according to the first embodiment.

FIG. 8 is a flowchart for showing a processing procedure in which a user designates a file destination of a transmission destination according to the first embodiment.

FIG. 9 is a view for showing an example of an error pop-up according to the first embodiment.

FIG. 10 is a view for showing examples of file destination setting screens divided into a host name input screen and an input screen for items other than the host name according to the first embodiment.

FIG. 11 is a flowchart for showing a processing procedure in which a user designates a file destination of a transmission destination according to a second embodiment.

FIG. 12 is a view for showing an example of a server certificate.

FIG. 13 is a view for showing an example of a list of certificate authorities that can be relied upon.

### DESCRIPTION OF THE EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

### Image Processing Apparatus Configuration

Below, explanation will be given for a first embodiment of the present invention. Firstly, with reference to FIG. 1, explanation will be given for a configuration of multi function peripheral (MFP) 100 having multiple functions which is an image processing apparatus according to embodiments. The multi function peripheral 100 is equipped with an image forming unit 101, a control unit 102, a finisher 103, a scanner unit 104, an operation unit 105, a network I/F 106, and a facsimile I/F 107.

The image forming unit 101 forms images on a printing medium (also referred to as a recording medium, paper, or a sheet) using an electrophotographic printing approach, or the like. The control unit 102 controls the multi function peripheral 100 comprehensively. The finisher 103 performs post-processing such as stapling processing. The scanner unit 104 reads an original image and outputs image data. The operation unit 105, in addition to displaying setting screens, or the like, inputs various data and commands. The network interface 106 transmits and receives image data via the network. The facsimile interface 107 transmits and receives data via fax (facsimile). Each of the components denoted by 101 and 103-107 is connected to the control unit 102 by a dedicated interface.

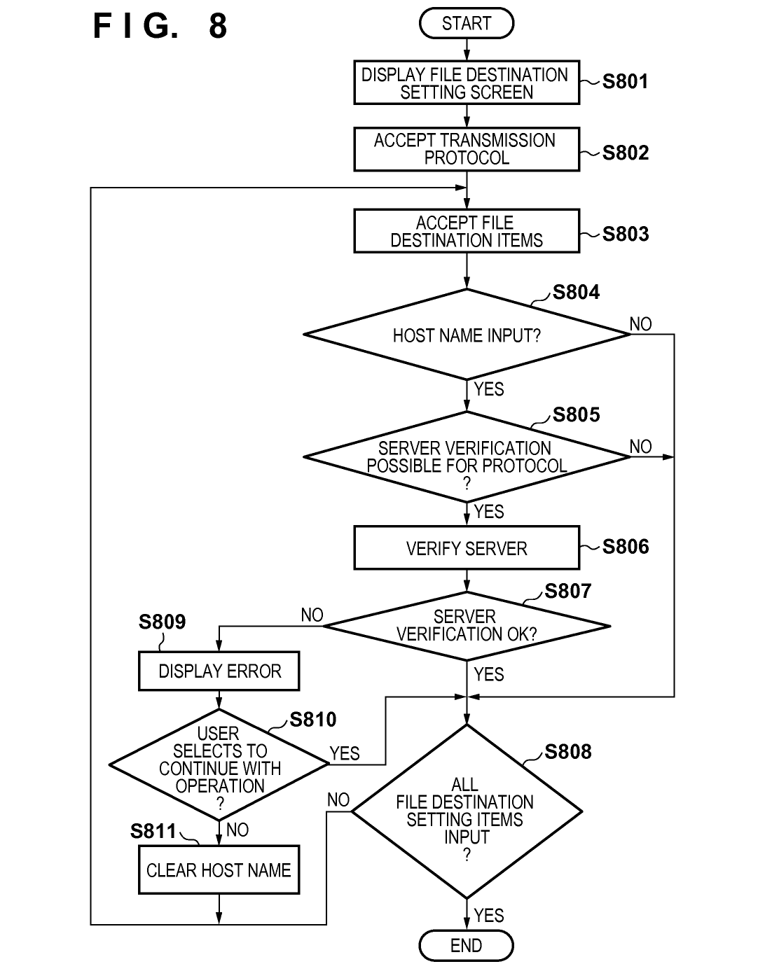

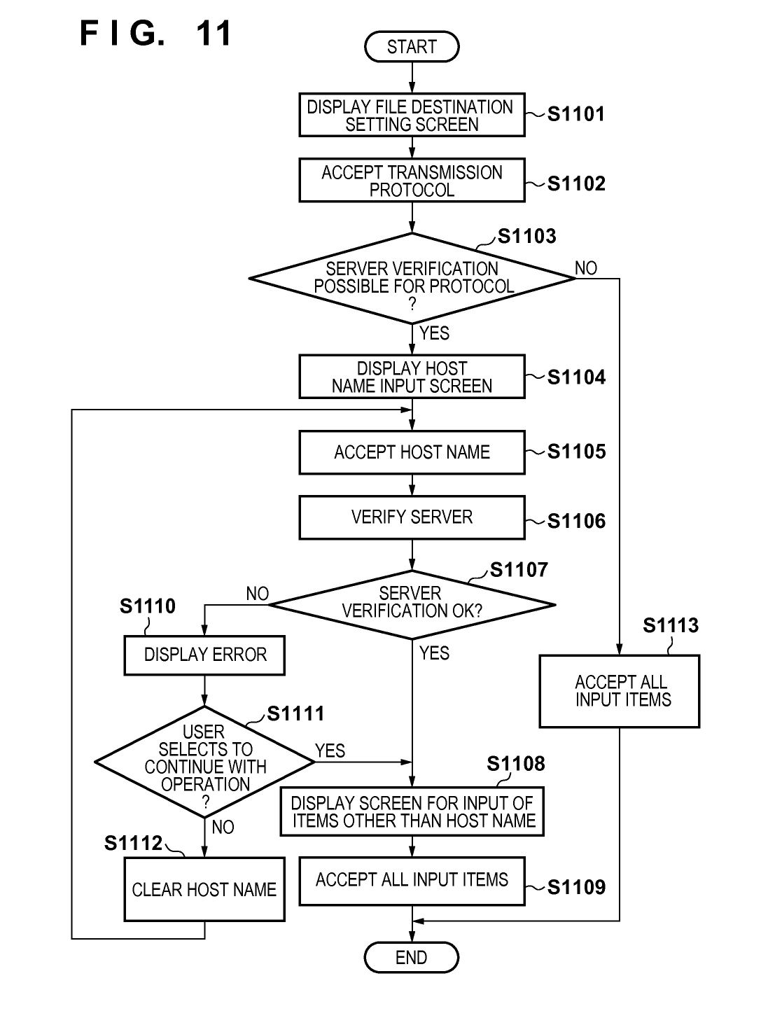

The control unit 102 comprises a central processing unit (CPU) 108 and a storage apparatus (a memory) 109 which are main components. In the memory 109 control programs corresponding to the flowcharts shown in FIG. 8 and FIG. 11, which will be explained later, are stored. Also, a control program for a setting dialog box, which will be explained later, and content describing operation screen information are stored.

<Software Configuration>

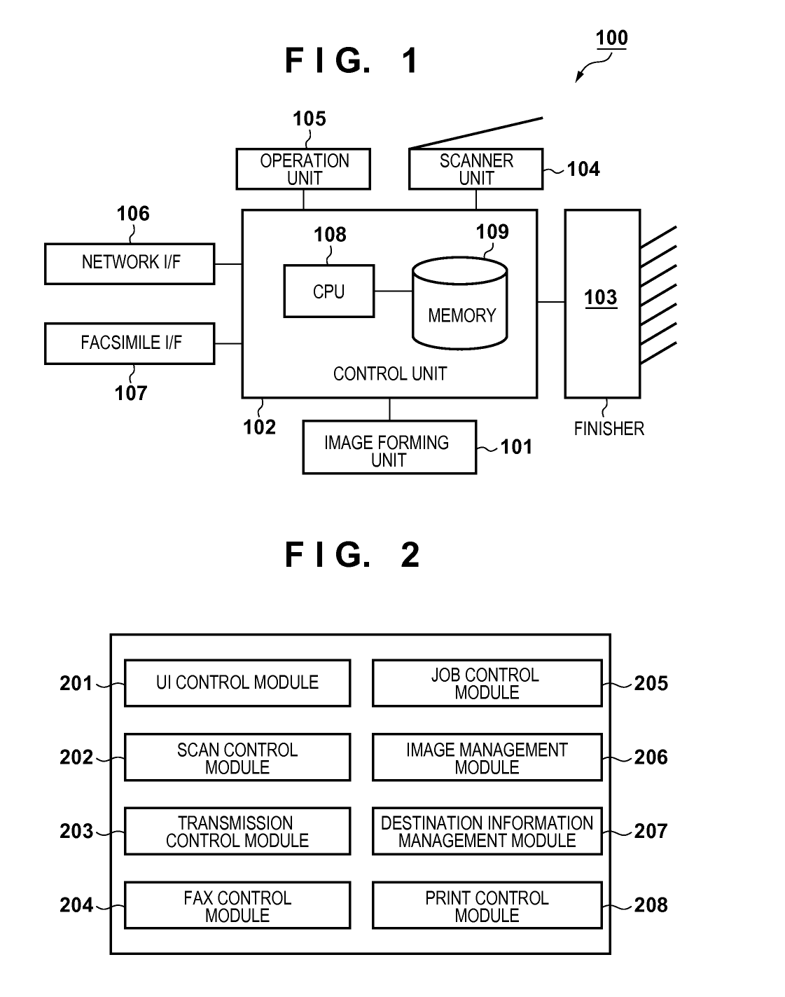

Next, with reference to FIG. 2 explanation will be given for a software configuration for controlling the multi function peripheral 100 according to embodiments. The multi function peripheral 100 is provided with a UI control module 201, a scan control module 202, a transmission control module 203, a fax control module 204, a job control module 205, a image management module 206, a destination information management module 207, and a print control module 208 as a software configuration.

The UI control module 201 displays operation screens on the operation unit 105, and controls a user interface (UI) by which operations of a user are accepted. The scan control module 202 controls processing for reading an original image by controlling the scanner unit 104. The transmission control module 203 controls processing for transmitting image data that the scan control module 202 read in to a destination that the user designated using the network interface 106. Specifically, the transmission control module 203 controls e-mail transmission, and transmission to a file server, or the like. The fax control module 204 controls transmission and reception of G3 fax using the facsimile interface 107.

The job control module 205 manages user transmission requests that the UI control module 201 accepts, execution statuses of such requests, and histories. The image management module 206 manages management information of images read in by the scanner unit 104. The destination information management module 207 manages transmission destination information of a transmission partner which is used in transmission processing. The print control module 208 controls printing to paper of image data read in by a scanner unit, or received fax documents, transmission result reports, or the like, using the image forming unit 101. This control software is stored in the memory 109 and executed by the CPU 108.

<System Configuration>

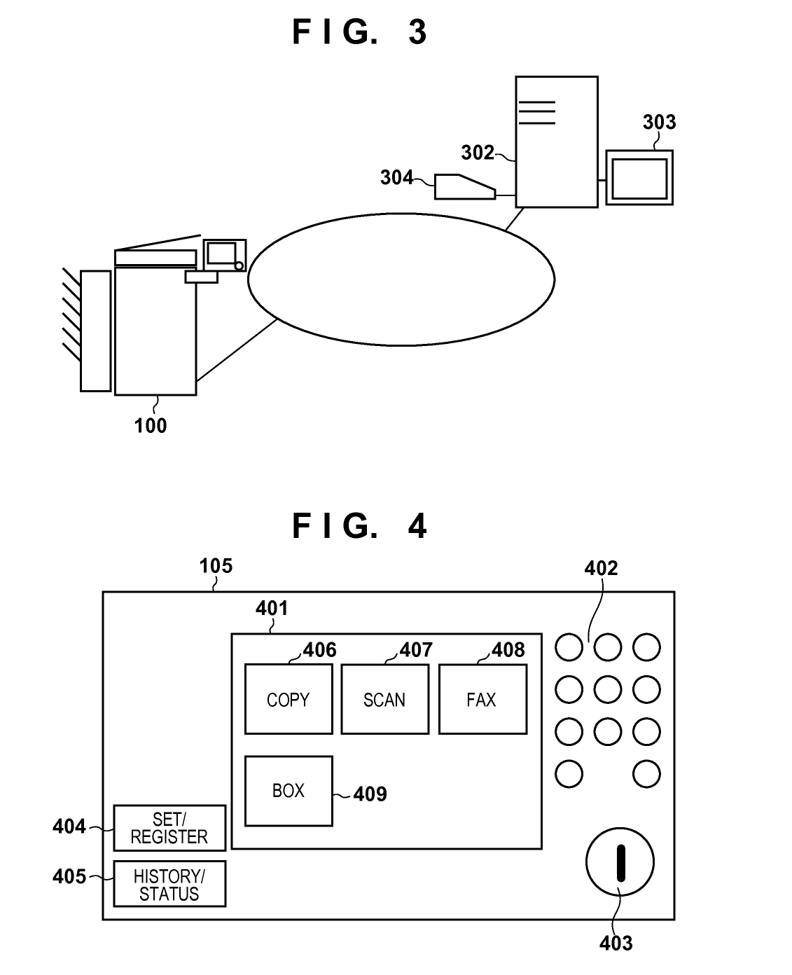

Next, explanation will be given for an example configuration of a system according to the embodiment with reference to FIG. 3. In the system in the present embodiment, the multi function peripheral 100 and a server computer 302 are included. The multi function peripheral 100 is an image processing apparatus to which the present invention is applied. The server computer 302 is an apparatus which is a transmission destination to which image data read in from an original is transmitted from the multi function peripheral 100. A display unit 303 and an input apparatus 304 are connected to the server computer 302. Various screens are displayed on the display unit 303. The input apparatus 304 is a user interface for accepting user input. Note, the types and numbers of the apparatuses shown here are just examples not intended to limit the present invention, and other forms may be applied.

<Screen Examples>

Below, explanation will be given for various screens displayed on the operation unit 105 of the multi function peripheral 100 with reference to FIGS. 4-7. FIG. 4 illustrates an example of a home screen displayed on the operation unit 105. As shown in FIG. 4, buttons configured as hardware and buttons displayed on a touch panel format liquid crystal screen as software are included in the operation unit 105 as parts of a user interface.

Reference numeral 401 denotes a selection screen, on which application selection buttons that a user presses to call operation screens for performing desired processing, are displayed. Here a “copy” button 406, a “scan” button 407, a “fax” button 408, and a “box” button 409 for calling operation screens of a copy function, a network scan function, a fax function, and a box function are displayed.

Also, a numeric keypad 402, and a start key 403 for designating a job initiation are arranged as buttons configured as hardware. In addition, a “set/register” screen calling button 404 for calling a setting screen of the device, and a “history/status” button 405 for calling a job history/status screen are arranged.

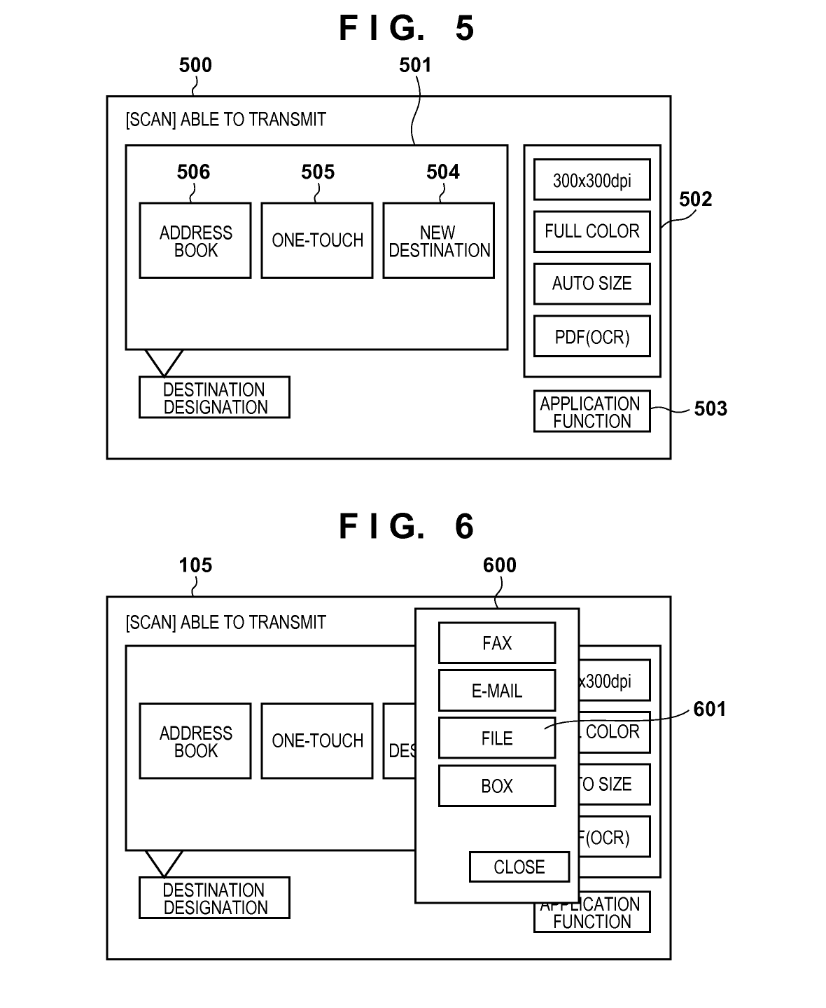

FIG. 5 shows an example a scan operation screen 500 which is displayed on the operation unit 105 and is transitioned to in a case where, in the selection screen 400, a user presses the “scan” button 407. The scan operation screen 500 includes destination input buttons 501 that a user can press to designate a transmission destination to which to transmit image data read in from an original by the multi function peripheral 100 or stored image data.

The destination input can be input by either an “address book”, a “one-touch”, or a “new destination” approach. For example, if a user presses a “new destination” button 504, it becomes possible to input the transmission destination directly. If a “address book” button 506 or a “one-touch” button 505 are pressed, a registered destination can be selected.

Reference numeral 502 denotes a setting button for setting parameters for when scanning such as those for a read resolution and a read color mode. For example, in a case where scanned image data is to be transmitted to a transmission destination and this information is set, reading of an original is performed with the set resolution and color mode, and the obtained image data is transmitted to the transmission destination set using one of the destination input buttons 501. Reference numeral 503 denotes an application function button for calling various detailed settings for when reading and transmitting.

FIG. 6 illustrates an example of a destination type selection screen 600 displayed on the operation unit 105 by a user pressing the “new destination” button 504 in the scan operation screen 500. Here, “fax”, “e-mail”, “file”, and “box” are displayed as selectable destination types. A user can select a desired destination type by pressing one of these buttons. For example, when a user presses a file destination selection button 601, an input screen necessary for file transmission destination is displayed.

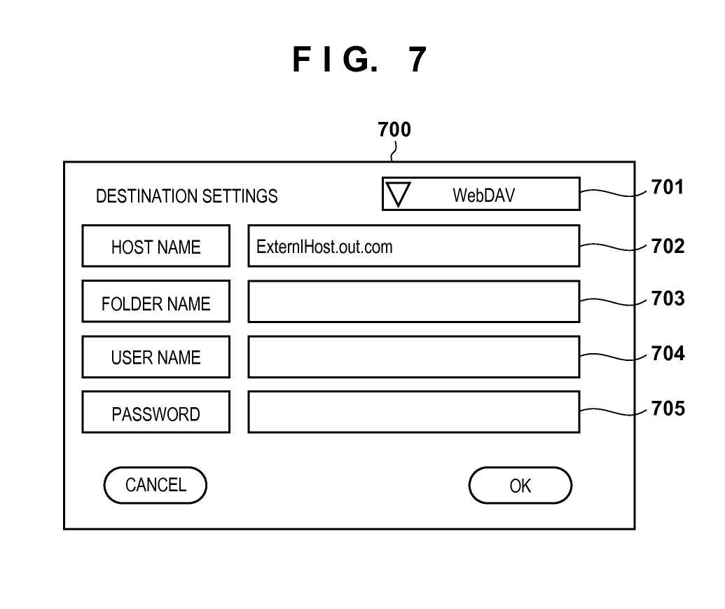

FIG. 7 illustrates an example of a file destination setting screen 700 displayed on the operation unit 105 by a user pressing the file destination selection button 601 in the destination type selection screen 600. As illustrated in FIG. 7, reference numeral 701 denotes a transmission protocol selection pull-down by which file transmission protocols are selectable. Here, various transmission protocols such as, for example, FTP, SMB, and WebDAV can be selected. FTP (File Transfer Protocol) is a communication protocol for performing a transfer of a file over a network. SMB (Server Message Block) is used for realization of file sharing and printer sharing through a LAN, and may operate as a process-to-process communication mechanism with authentication. WebDAV (Web-based Distributed Authoring and Versioning) is a protocol for realizing a file system with an objective of file management on a server, and all content management can be performed by HTTP alone. Reference numeral 702 is an input area for inputting a host name of a transmission destination, and corresponds to a first screen. Also reference numerals 703, 704, and 705 each are areas for inputting authentication information such as a transmission destination folder name a user name, or an authentication password used to authenticate upon file transmission, and these correspond to second screens. When a cancel button is pressed in a state in which these parameters are set, the input parameters are cleared, and the original screen is transitioned to, and when the OK button is pressed, the input parameters are set.

<Setting Processing>

Next, explanation will be given, with reference to FIG. 8, for a processing procedure for setting processing performed when a user sets the file transmission destination. The processing explained below is performed by the CPU 108 reading out and executing a control program stored in the memory 109.

Firstly, explanation will be given for acceptance of setting items of the file destination by the UI control module 201. In step S801, the UI control module 201 displays the file destination setting screen 700 on the operation unit 105. In step S802, the UI control module 201 detects a selection state of a transmission protocol selection pull-down 701, and accepts the transmission protocol to use for file transmission that the user selected. For example, a transmission protocol such as FTP, SMB, or WebDAV is accepted.

In step S803, the UI control module 201 accepts input of any of the “host name”, the “folder name”, the “user name”, or the “password”, which are file destination setting items settable by the file destination setting screen 700. Note, hereinafter the “host name”, the “folder name”, the “user name”, and the “password” are referred to collectively as transmission related information. In other words, the file destination setting screen 700 is a setting screen by which all setting items included in the transmission related information are settable. Also, the host name is a name of a destination device (here the server) to which a file is transmitted. In step S804, the UI control module 201 determines whether or not the file destination setting item accepted in step S803 is the host name. Here, if the file destination setting item is not the host name, the processing proceeds to step S808, and if the file destination setting item is the host name, the processing proceeds to step S805. In step S808, the UI control module 201 determines whether or not all items of the file destination setting item are input. If all of the items are input, information of all the input items is confirmed to be valid information, and the processing ends, but if all of the items have not been input, the processing returns to step S803.

Next, explanation will be given for a determination of a possibility of a server verification on the UI control module 201. In step S805, the UI control module 201 determines whether or not a server verification is possible for the transmission protocol accepted in step S802. For example, in a state in which SSL is usable, a server verification is possible for a WebDAV transmission. Here, the server verification determines whether or not a server apparatus is a malicious server, i.e. whether or not the server has reliability. Here, after a server is determined to have reliability, the server is notified of confidential information such as authentication information of a user. When, in step S805, it is determined that server verification is not possible for the protocol, the processing proceeds to step S808 and when it is determined that server verification is possible for the protocol, the processing proceeds to step S806.

Next, explanation will be given for a server verification by the transmission control module 203. The UI control module 201 notifies the transmission control module 203 of the host name information from the file destination setting items accepted in step S803, and requests a server verification. In step S806, the transmission control module 203 identifies the server (for example, the server computer 302) which has the host name of which the UI control module 201 notified, obtains a certificate certifying reliability of the server from the server and performs a verification of the obtained server certificate. With this, it is possible to verify the reliability of the server.

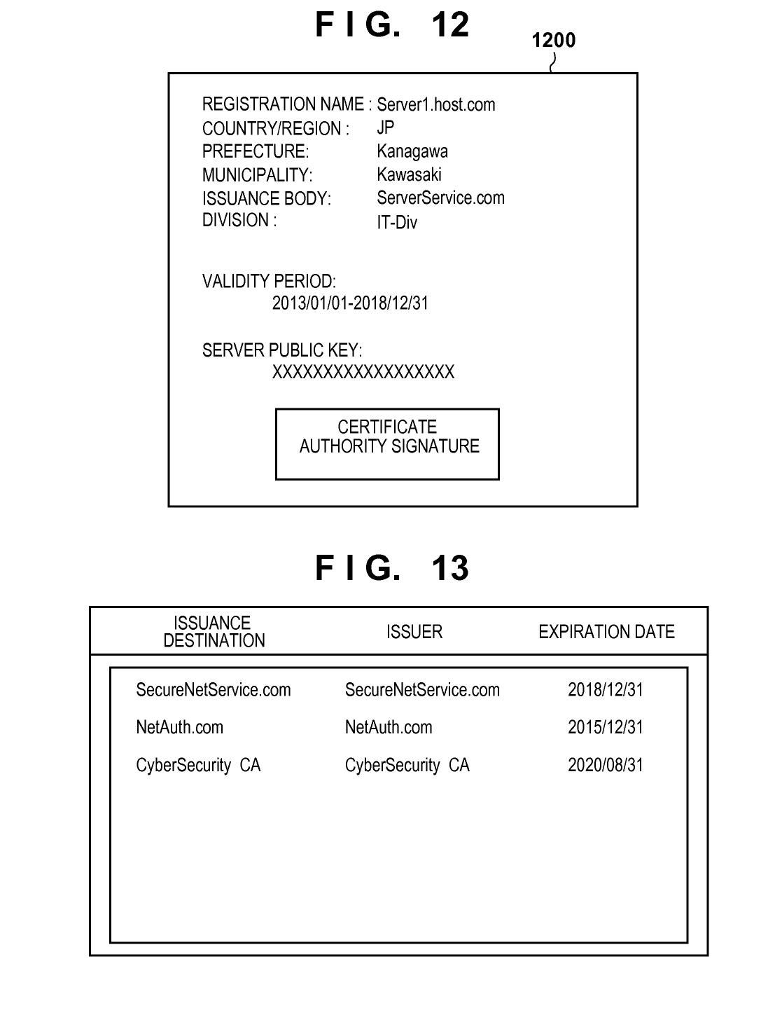

FIG. 12 illustrates an example of a server certificate 1200 obtained from the server. In the server certificate 1200, Server1.host.com, which is a server registration name, ServerService.com, which is a server certificate issuance body, information such as a validity period, and a signature of a certificate authority that authenticated the server certificate 1200 are included. For example, the transmission control module 203 compares the signature of the certificate authority included in the server certificate against the signature of a certificate authority that can be relied upon which was saved on the multi function peripheral 100 in advance, and determines that the server certificate can be relied upon if the server certificates match. FIG. 13 shows an example of a signature list of the certificate authorities that can be relied upon saved on the device in advance. The signature list defines an issuance destination, an issuer, and an expiration date of the signature in association for each signature. Accordingly, the transmission control module 203 determines whether or not the same issuance destination or issuer is included within the signature list shown in FIG. 13 using the information of the issuance body included in the server certificate obtained from the server as a search key, for example. If there is a match, determination is made as to whether or not the signature is the same, and if the signature is the same, it is determined that the server is a server that can be relied upon.

In other words, a server that has reliability is a server having a signature of a certificate authority registered in the multi function peripheral 100 in advance. Note, here the above described determination approach is used, but this is not intended to limit the present invention to this determination approach, and other determination approaches may be used. The transmission control module 203 notifies the UI control module 201 of the result of the server verification, and the processing proceeds to step S807.

Next, explanation will be given for a usage of the verification result by the UI control module 201. In step S807 the UI control module 201 receives the server verification result from the transmission control module 203 and determines whether or not the verification result indicates that the server can be relied upon. In a case where the server can be relied upon, the processing proceeds to step S808, and in a case where the server cannot be relied upon, the processing proceeds to step S809.

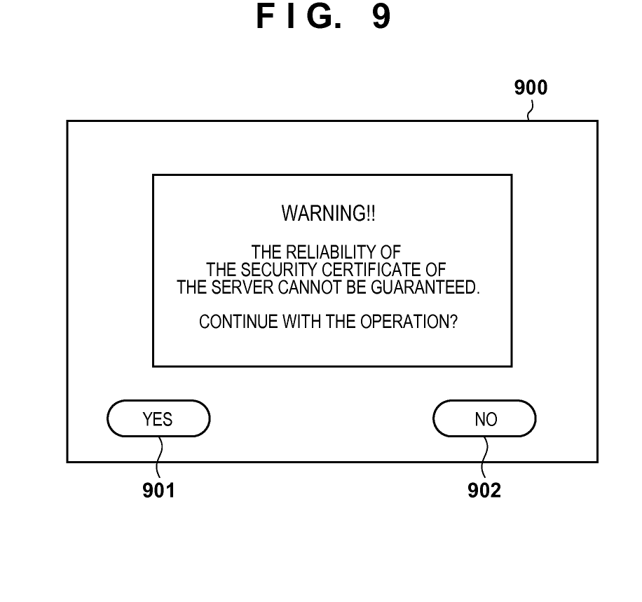

In step S809, the UI control module 201 displays an error pop-up shown in FIG. 9 to the operation unit 105 and confirms with the user whether or not to continue with the destination setting operation. As illustrated in FIG. 9, in addition to it being displayed on an error pop-up 900 that the reliability of the certificate obtained from the server cannot be guaranteed, buttons 901 and 902 are displayed on the error pop-up 900 for selection of whether or not to continue with the operation.

In step S810, the UI control module 201 determines whether or not the selection of the user input via the error pop-up 900 is for continuing with the operation. In other words, the UI control module 201 determines whether or not the button 901 is pressed. In a case where the button 901 is pressed, the processing proceeds to step S808, and in a case where the button 902 is pressed, the processing proceeds to step S811. In step S811, the UI control module 201 clears the input host name, and returns the processing to step S803.

When the processing of the above described flowchart ends, the setting information such as that for valid transmission related information and the data type when a file is transmitted to the server, for example, is confirmed. When this information is confirmed, the multi function peripheral 100 transmits to the server, which is the destination device, the authentication information such as the “user name” and the “password” included in the transmission related information, and executes the transmission of the file.

As explained above, by virtue of the image processing apparatus (the multi function peripheral) according to the embodiment, using transmission related information for when data is transmitted that is input via a setting screen, a certificate that certifies a reliability of a destination device is obtained from the destination device to which a file, or the like, is transmitted. In addition, the image processing apparatus, using the obtained certificate, verifies whether or not the destination device is an apparatus that has reliability, and if the destination device is an apparatus that has reliability, confirms the set transmission related information to be valid information. In this way, the image processing apparatus according to the embodiment, having verified whether or not the destination device is an apparatus having reliability, can transmit authentication information, for which security is important, only when the apparatus has reliability With this, leaking to a malicious server authentication information input when setting the transmission destination of data can be prevented.

### Second Embodiment

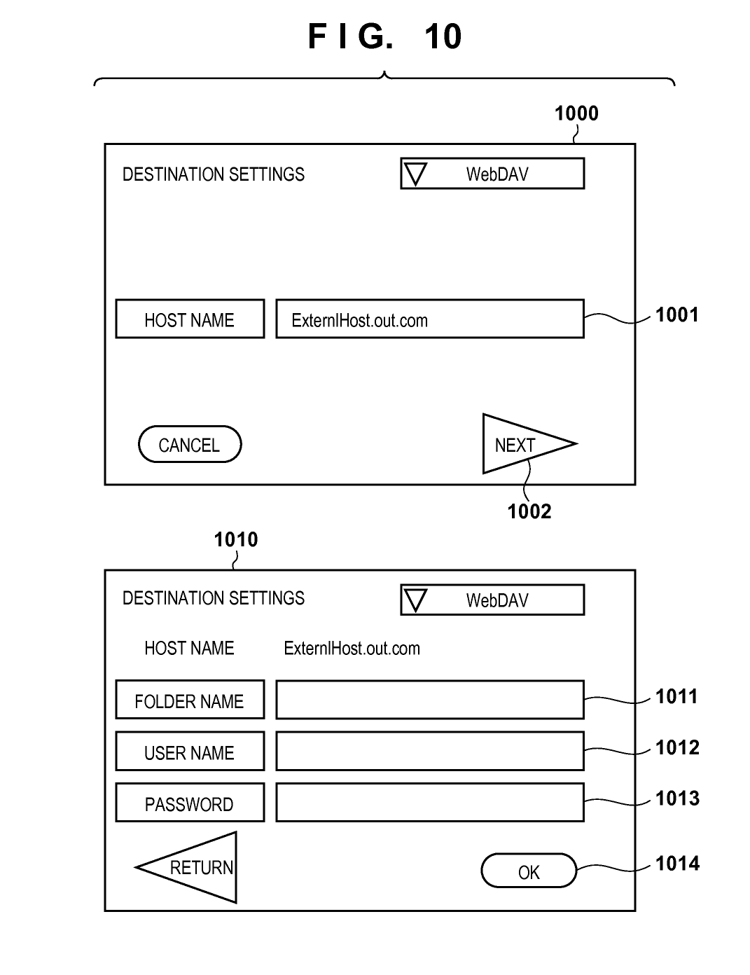

Below, with reference to FIG. 10 and FIG. 11, explanation will be given for a second embodiment of the present invention. In the above described first embodiment, explanation was given for an example in which the file destination setting screen 700, which includes input items for the “host name”, the “folder name”, the “user name”, and the “password” all in one screen, was employed. However, a user does not necessarily input the “host name” first. The possibility exists that when the host name is input, another item is already input. Here, in a case where a pop-up for reporting that there is a problem in a server verification is displayed, it is difficult for a user who lacks knowledge of file transmission techniques to know which input item caused the problem. Also, in a case where a pop-up is displayed in a state in which the “user name” and the “password” are already input, there is a possibility that the user will be concerned that the server has been notified of the authentication information. So, in this embodiment, explanation will be given for a configuration in which, if server verification is possible for the transmission protocol, input screens for the host name and for other items are clearly separated.

Reference numeral 1000 of FIG. 10 denotes a host name setting screen 1000 than has an input area for the host name only. When a user first inputs the host name into an input area 1001, and then the user presses a “next” button 1002 in the host name setting screen 1000, transition is made to a file destination setting screen 1010 shown in FIG. 10. The file destination setting screen 1010 has input areas 1011-1013 for the “folder name”, the “user name”, and the “password”. In other words, the file destination setting screen 1010 is a setting screen by which setting items other than that for the host name (other than the name of the destination device) are settable. The file destination of the transmission destination is confirmed by an OK button 1014 of the file destination setting screen 1010 being pressed after transition is made to a file destination setting screen 1010.

<Setting Processing>

Next, explanation will be given, with reference to FIG. 11, for a processing procedure for setting processing performed when a user sets the file transmission destination. The processing explained below is performed by the CPU 108 reading out and executing a control program stored in the memory 109.

Firstly, explanation will be given for a determination of a possibility of a server verification on the UI control module 201. In step S1101, the UI control module 201 displays the file destination setting screen 700 on the operation unit 105. In step S1102, the UI control module 201 detects a selection state of the transmission protocol selection pull-down 701, and accepts the transmission protocol to use for file transmission that the user selected.

Continuing on, in step S1103, the UI control module 201 determines whether or not server verification is possible for the transmission protocol accepted in step S1102. For example, in a state in which SSL is usable, a server verification is possible for a WebDAV transmission. Here, if the server verification is possible, the processing proceeds to step S1104, and if the server verification is impossible, the processing proceeds to step S1113. In step S1113, the UI control module 201, via the file destination setting screen 700 displayed in step S1101, accepts all of the file destination setting items (the “host name”, the “folder name”, the “user name”, and the “password”), confirms that the information of all of the input items is valid information, and the processing ends.

Next, explanation will be given for a display of a setting screen for a protocol for which a server verification is possible by the UI control module 201. In step S1104, the UI control module 201 displays on the operation unit 105 the host name setting screen 1000 shown in FIG. 10, which includes the input area 1001 for the host name only in place of the file destination setting screen 700 displayed in step S1101. In step S1105, the UI control module 201 accepts an input of a host name via the host name setting screen 1000 from the user.

Next, explanation will be given for a server verification by the transmission control module 203. The UI control module 201 notifies the transmission control module 203 of the host name information accepted in step S1105 and requests the server verification. In step S1106, the transmission control module 203 obtains the certificate from a server (for example, the server computer 302) having the host name of which the UI control module 201 notified, and by performing a verification of the obtained server certificate, verifies the reliability of the server.

The transmission control module 203 compares the signature of the certificate authority included in the server certificate 1200 shown in FIG. 12 against the signature of a certificate authority that can be relied upon which was saved in advance, and determines that the server certificate can be relied upon if the server certificates match. The transmission control module 203 notifies the UI control module 201 of the result of the server verification.

Next, explanation will be given for a usage of the verification result by the UI control module 201. In step S1107 the UI control module 201 receives the server verification result from the transmission control module 203 and determines whether or not the verification result indicates that the server can be relied upon. In a case where the server can be relied upon, the processing proceeds to step S1108, and in a case where the server cannot be relied upon, the processing proceeds to step S1110.

In step S1108, the UI control module 201 displays, on the operation unit 105, the file destination setting screen 1010 for items other than the host name, which includes the input areas 1011-1013 for the “folder name”, the “user name”, and the “password”. In step S1109, the UI control module 201, via the file destination setting screen 1010, accepts the input of all of the remaining file destination items, confirms that the information of all of the input items is valid information, and the processing ends.

Meanwhile, in step S1110, the UI control module 201 displays to the operation unit 105 the error pop-up 900 shown in FIG. 9, and prompts the user to determine whether to continue with the destination setting operation. After that, in step S1111, the UI control module 201 determines whether or not the selection of the user is to continue with the operation. If the selection is to continue with the operation, the processing proceeds to step S1108, and if the selection is to not continue with the operation, the processing proceeds to step S1112. In step S1112, the UI control module 201 clears the input host name, and returns the processing to step S1105. When this flowchart ends, the multi function peripheral 100, in accordance with the set transmission related information, transmits the file (data) to the corresponding server (apparatus).

As explained above, by virtue of the information processing apparatus, unlike the above described first embodiment, firstly a setting screen, by which only the host name (the name of the destination device) is settable, is displayed in order to determine whether or not the destination device is an apparatus that has reliability. When the host name is set via this setting screen, the destination device is verified, and a setting screen by which the other setting items are settable is displayed if the apparatus has reliability. With this, in addition to more reliably reducing a risk of information leakage, it is possible for users to determine instantly that an error is due to the host name that they themselves input when an error is displayed in a case where the destination device is a malicious server, for example. For example, in a case of a setting screen in which all of the setting items are settable as in the above described first embodiment, it is difficult for a user to instantly determine which setting item caused the error when the error is displayed.

### OTHER EMBODIMENTS

In the above described first and second embodiments, examples are shown in which a user sets a file destination as a new destination. However, the same effect can be obtained when the present invention is applied to processing for a case in which the user registers the file destination using the address book, or the one-touch function. Note, because such processing is the same as the processing in the above described first and second embodiments, explanation is not given again.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-248345 filed on Nov. 29, 2013, which is hereby incorporated by reference herein in its entirety.

What is claimed is:

1. An image processing apparatus, comprising:
a first display control unit configured to control a display unit to display a first screen for inputting a host name of a destination server;
a verification unit configured to perform, based on the host name input via the first screen, a verification of the destination server;
a second display control unit configured to control the display unit to display, based on a result of the verification by the verification unit, a second screen for inputting authentication information for logging in to the destination server; and
a transmission unit configured to transmit image data using the authentication information input via the second screen.

2. The image processing apparatus according to claim 1, further comprising a reading unit configured to generate the image data by reading an image on an original, wherein
the transmission unit transmits the image data generated by the reading unit.

3. The image processing apparatus according to claim 1, wherein the second display control unit, in a case where the verification by the verification unit succeeds, control the display unit to display the second screen, and in a case where the verification by the verification unit fails, control the display unit to display an error screen.

4. The image processing apparatus according to claim 3, wherein the second display control unit, even in the case where the verification by the verification unit fails, control the display unit to display the second screen if a predetermined instruction is performed by a user after the error screen is displayed.

5. The image processing apparatus according to claim 1, further comprising a selection unit configured to select a transmission protocol for the image data, wherein
if the transmission protocol selected by the selection unit is a first transmission protocol, the second display control unit, based upon the result of the verification by the verification unit, control the display unit to display the second screen, and if the transmission protocol selected by the selection unit is a second transmission protocol, the second display control unit control the display unit to display the second screen without the verification unit performing the verification.

6. The image processing apparatus according to claim 1, wherein the verification unit obtains a certificate from the destination server and verifies the destination server based on the obtained certificate.

7. An image processing apparatus, comprising:
a first acceptance unit configured to accept a host name of a destination server;
a verification unit configured to perform, based on the host name that the first acceptance unit accepts, a verification of the destination server;
a second acceptance unit configured to, based on a result of the verification by the verification unit, accept authentication information for logging in to the destination server; and
a transmission unit configured to transmit image data using the authentication information that the second acceptance unit accepts.

8. The image processing apparatus according to claim 7, further comprising a reading unit configured to generate the image data by reading an image on an original, wherein
the transmission unit transmits the image data generated by the reading unit.

9. The image processing apparatus according to claim 7, wherein the verification unit obtains a certificate from the destination server and verifies the destination server based on the obtained certificate.

10. A method of controlling an image processing apparatus, comprising:
controlling a display unit to display a first screen for inputting a host name of a destination server;
performing, based on the host name input via the first screen, a verification of the destination server;
controlling the display unit to display, based on a result of the verification, a second screen for inputting authentication information for logging in to the destination server; and
transmitting image data using the authentication information input via the second screen.

11. A method of controlling an image processing apparatus, comprising:
accepting a host name of a destination server;
performing, based on the host name, a verification of the destination server;
based on a result of the verification, accepting authentication information for logging in to the destination server; and
transmitting image data using the authentication information.

12. A non-transitory computer-readable storage medium storing a program for causing a computer to execute a method of controlling an image processing apparatus, the program comprising:
controlling a display unit to display a first screen for inputting a host name of a destination server;
performing, based on the host name input via the first screen, a verification of the destination server;
controlling the display unit to display, based on a result of the verification, a second screen for inputting authentication information for logging in to the destination server; and
transmitting image data using the authentication information input via the second screen.

13. A non-transitory computer-readable storage medium storing a program for causing a computer to execute a method of controlling an image processing apparatus, the program comprising:
accepting a host name of a destination server;
performing, based on the host name, a verification of the destination server;
based on a result of the verification, accepting authentication information for logging in to the destination server; and
transmitting image data using the authentication information.
